(19) United States
(12) Patent Application Publication
(10) Pub. No.: US 2020/0250717 A1
(43) Pub. Date: Aug. 6, 2020

(54) PROOF-OF-VALUE PROVENANCE FOR DATA MARKETPLACE ENVIRONMENT

(71) Applicant: EMC IP Holding Company LLC, Hopkinton, MA (US)

(72) Inventor: Stephen J. Todd, Center Conway, NH (US)

(21) Appl. No.: 16/263,065

(22) Filed: Jan. 31, 2019

(51) Int. Cl. G06Q 30/02; G06F 16/901; G06F 16/907

(52) U.S. Cl. CPC G06Q 30/0283; G06F 16/9014; G06F 16/907; G06F 16/9027

(57) ABSTRACT

Techniques for data valuation for a data marketplace environment are provided. For example, a method comprises the following steps. One or more data structures representing one or more valuation results for a given data set are obtained. Each of the one or more valuation results are computed based on one or more data valuation methodologies. The one or more data structures have unique references respectively assigned thereto. A proof-of-value data structure is generated for the given data set. The proof-of-value data structure comprises entries for each of the one or more valuation results computed for the given data set and the corresponding unique reference that points to the corresponding data structure that represents each valuation result. Information about or at least part of the proof-of-value data structure can be sent to a data marketplace environment to assist in a potential transaction involving the given data set.

### FIELD

The field relates generally to information processing systems and, more particularly, to techniques for data valuation for a data marketplace environment.

### BACKGROUND

A data marketplace is a computing platform on which data producers sell their data to data consumers. There is an ever-growing number of public data marketplaces in which data consumers (buyers) and data producers (sellers) can interact including, but not limited to, DEX, Datastreamx, ESRI, and LexisNexis. One or more such public data marketplaces are considered a data marketplace environment. Two foundational pieces of information that allow buyers in a data marketplace to make decisions about purchasing a given data set include basic metadata about the given data set (i.e., content, size, creation date), and the price of the given data set (i.e., how much is the data owner requesting for purchase of the data). While these pieces of information are typically considered the minimal amounts of information to consider in a data purchase, there is still a significant amount of risk that comes with a decision to purchase that is solely based on such superficial information.

### SUMMARY

Embodiments of the invention provide techniques for data valuation for a data marketplace environment.

For example, in one embodiment, a method comprises the following steps. One or more data structures representing one or more valuation results for a given data set are obtained. Each of the one or more valuation results are computed based on one or more data valuation methodologies. The one or more data structures have unique references respectively assigned thereto. A proof-of-value data structure is generated for the given data set. The proof-of-value data structure comprises entries for each of the one or more valuation results computed for the given data set and the corresponding unique reference that points to the corresponding data structure that represents each valuation result.

These and other features and advantages of the invention will become more readily apparent from the accompanying drawings and the following detailed description.

### BRIEF DESCRIPTION OF THE DRAWINGS

FIG. 1 illustrates a value tree generation engine and its corresponding environment according to an illustrative embodiment.

FIG. 2 illustrates a value tree according to an illustrative embodiment.

FIG. 3 illustrates storage of value trees according to an illustrative embodiment.

FIG. 4 illustrates a proof-of-value provenance manager and its corresponding environment according to an illustrative embodiment.

FIG. 5 illustrates a valuation table with unique value tree references according to an illustrative embodiment.

FIG. 6 illustrates valuation table versioning according to an illustrative embodiment.

FIG. 7 illustrates a process of utilizing a valuation table in a data marketplace environment according to an illustrative embodiment.

FIG. 8 illustrates a data valuation methodology for a data marketplace environment according to an illustrative embodiment.

FIG. 9 illustrates a processing platform used to implement a data valuation methodology for a data marketplace environment according to an illustrative embodiment.

### DETAILED DESCRIPTION

Illustrative embodiments may be described herein with reference to exemplary cloud infrastructure, data repositories, data centers, data processing systems, computing systems, information processing systems, data storage systems and associated servers, computers, storage units and devices and other processing devices. It is to be appreciated, however, that embodiments of the invention are not restricted to use with the particular illustrative system and device configurations shown. Moreover, the phrases “cloud infrastructure,” “data repository,” “data center,” “data processing system,” “computing system,” “data storage system,” “information processing system,” “data lake,” and the like as used herein are intended to be broadly construed so as to encompass, for example, cloud computing or storage systems, as well as other types of systems comprising distributed virtual infrastructure.

For example, some embodiments comprise a cloud infrastructure hosting multiple tenants that share cloud computing resources. Such systems are considered examples of what are more generally referred to herein as cloud computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system.

On the other hand, cloud infrastructures that are used by multiple enterprises, and not necessarily controlled or managed by any of the multiple enterprises but rather are respectively controlled and managed by third-party cloud providers, are typically considered “public clouds.” Thus, enterprises can choose to host their applications or services on private clouds, public clouds, and/or a combination of private and public clouds (hybrid clouds) with a vast array of computing resources attached to or otherwise a part of information technology (IT) infrastructure. However, a given embodiment may more generally comprise any arrangement of one or more processing devices.

As used herein, the following terms and phrases have the following illustrative meanings:

“valuation” as utilized herein is intended to be broadly construed so as to encompass, for example, a computation and/or estimation of something's worth or value; in this case, data valuation is a computation and/or estimation of the value of a data set for a given context;

“context” as utilized herein is intended to be broadly construed so as to encompass, for example, surroundings, circumstances, environment, background, settings, characteristics, qualities, attributes, descriptions, and/or the like, that determine, specify, and/or clarify something; in this case, for example, context is used to determine a value of data;

“client” as utilized herein is intended to be broadly construed so as to encompass, for example, an end user device or an application program of a computing system or some other form of computing platform;

“data” as utilized herein is intended to be broadly construed so as to encompass, for example, electronic or digital data;

“metadata” as utilized herein is intended to be broadly construed so as to encompass, for example, data that describes other data, i.e., data about other data;

“node” as utilized herein is intended to be broadly construed so as to encompass, for example, a data structure element with which an input to an analytic process, a result of execution of an analytic process, or an output from an analytic process is associated, along with metadata if any, examples of nodes include, but are not limited to, structured database nodes, graphical nodes, and the like;

“connector” as utilized herein is intended to be broadly construed so as to encompass, for example, a data structure element which connects nodes in the data structure, and with which transformations or actions performed as part of the analytic process are associated, along with metadata if any; examples of connectors include, but are not limited to, arcs, pointers, links, etc. (while illustrative examples herein refer to connectors as arcs, it is understood that embodiments of the invention are not so limited);

“analytic sandbox” as utilized herein is intended to be broadly construed so as to encompass, for example, at least a part of an analytic computing environment (including specifically allocated processing and storage resources) in which one or more analytic processes are executed on one or more data sets; for example, the analytic process can be part of a data science experiment and can be under the control of a data scientist, an analytic system, or some combination thereof; and

“leveraging” or “leverage” as utilized herein is intended to be broadly construed so as to encompass, for example, utilization of data to obtain one or more benefits. For example, data of an enterprise can be monetized in a data marketplace environment whereby an enterprise obtains cryptocurrency in return for its data. However, an enterprise can leverage its data to receive in return one or more benefits other than cryptocurrency, e.g., allocation and use of computing resources that benefit the operational performance of an enterprise's IT and/or operational technology (OT) infrastructure (e.g., compute, storage and/or network capacities). Data can also be leveraged in exchange for other data. In some cases, data can be leveraged by donating the data and receiving a taxation benefit or simply good will.

As mentioned above, a purchase of data based solely on a minimal amount of information, including price and basic identifying metadata (i.e., content, size, creation date), carries many risks. Reliance on such a superficial (or surface) view of the content often results in problems that are only discovered after purchase. A description of some of the many data marketplace problems associated with current methodologies will now be described below.

No proof-of-value. A price must be associated with a data set for sale. However, the buyer of the data set may have no context within which to know whether or not the price is reasonable. For example, if a data seller is selling a data set for $15K, how can the potential buyer know how that price was calculated? The communication of this knowledge is currently not part of a data transaction.

No proof-of-quality. A data set advertisement may include the semantics of the content (e.g., the data types of the rows and columns in a database) without any context of how complete, accurate, and clean that data set is. A purchase of low-quality data may result in a buyer receiving less value than the data set is valued at.

Stale data versus live data. While a data seller may advertise the “creation date” of a given data set, there is typically no accompanying information about how often that data set is used (e.g., is it “live” and frequently/regularly accessed, or is it “stale” and not recently accessed).

Historical view of value. A potential data buyer has no insight into the rise (or fall) of the value of data over time. This may introduce risk for the buyer should the value of the data decrease over time. It also could be a signal that the value of the data is on the rise. However, existing sales of data in data marketplaces do not provide such insight.

Frequency and record of purchase. There is typically no mechanism to determine how many other buyers have purchased a data set. It is realized herein that this information may provide valuable insight into the worth of the data set. In addition, there is no accompanying information about the value that other purchasers have paid, whether it be a record of every individual purchase, and/or other information such as mean or median price paid.

Lack of purchase feedback. Sellers of data sets have no existing mechanism to gather feedback from previous data purchasers about how the data set was used and/or the value achieved post-purchase. It is realized herein that this feedback can be quite useful to sellers to establish that previous buyers have achieved a certain amount of value due to the purchase of a given data set.

Lack of buyer feedback incentive. A seller may wish to receive feedback on the value of a data sale but currently has no mechanism to induce buyers to leave feedback once they have purchased the data and used it with some degree of success.

Cost of providing proof-of-value metadata. If data buyers wish to gain more insight into the actual historical value of a data set, this can come at a cost to a data producer as they deploy methods and systems for generating and storing that metadata. Other than the (not guaranteed) sale of the data, there is no existing mechanism for a data seller to monetize proof-of-value metadata separate from the sale of the actual data set.

Illustrative embodiments overcome the above and other problems associated with the sale of data in a data marketplace environment. More particularly, illustrative embodiments comprise techniques for providing proof-of-value provenance during a potential data transaction in a data marketplace environment. In illustrative embodiments, proof-of-value provenance is provided by generating and maintaining a data structure in the form of a value tree. A value tree, as illustratively described herein, is considered an example of a proof-of-value provenance graph.

While various forms of valuation data structures can be used to provide provenance in various illustrative embodiments, one example of a data value structure and methodology that can be used and/or adapted is described in U.S. Ser. No. 15/135,817, filed on Apr. 22, 2016 and entitled “Data Value Structures,” the disclosure of which is incorporated by reference herein in its entirety.

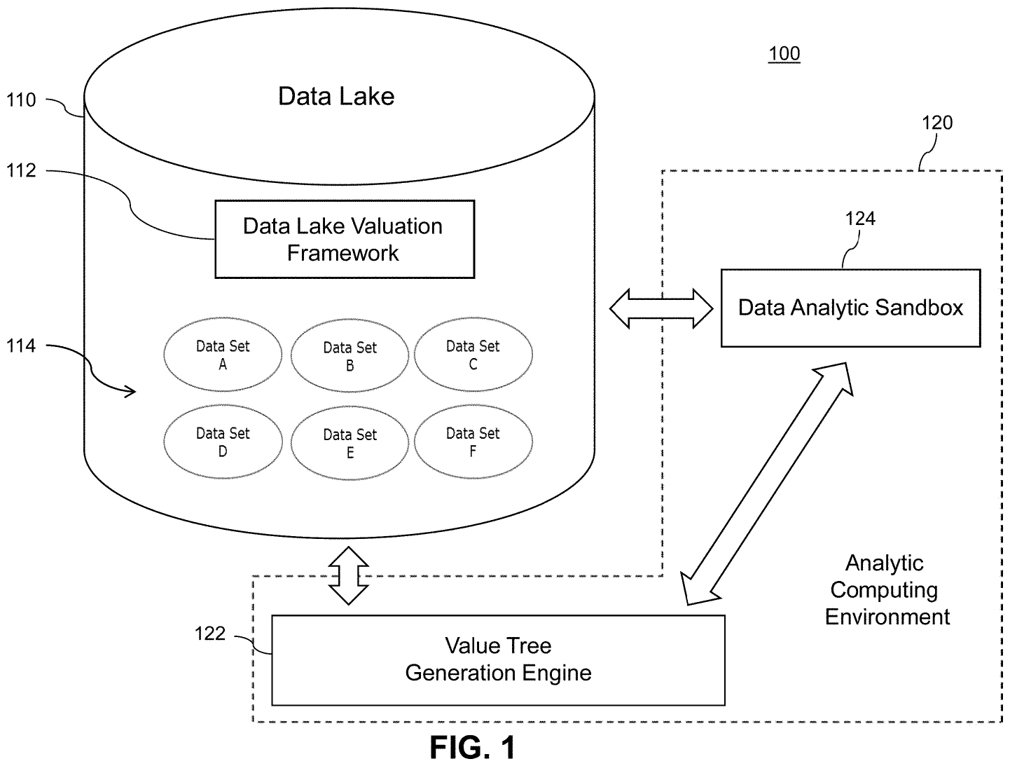

FIG. 1 illustrates a value tree generation and its corresponding environment 100, according to an embodiment of the invention. As shown, environment 100 comprises a data lake 110 which comprises a data lake valuation framework 112 and a plurality of data sets 114 (e.g., data sets A, B, C, D, E, and F). It is assumed that one or more of the plurality of data sets 114 will be advertised for sale by the owner of the data lake 110 in a data marketplace environment. It is to be appreciated, however, that embodiments described herein are not limited to data sets obtained from data lakes.

Also shown in FIG. 1 is analytic computing environment 120 which comprises a value tree generation engine 122 coupled to a data analytic sandbox 124. The components of the analytic computing environment 120 are coupled to the components of the data lake 110. While components of the analytic computing environment 120 are shown separate from components of the data lake 110, it is to be appreciated that some or all of the components can be implemented together.

The analytic computing environment 120 is configured to execute an analytic process (e.g., a data science experiment) on one or more of the plurality of data sets 114 within the data analytic sandbox 124. It is to be appreciated that data sets sold in data marketplaces, according to illustrative embodiments, are not limited to data sets that are subjected to analytic processes. However, description of FIGS. 1-3 to follow will use analytic processing on one or more data sets by way of a non-limiting example.

In some embodiments, data analytic sandbox 124 can be used to condition and experiment with the data and preferably has: (i) large bandwidth and sufficient network connections; (ii) a sufficient amount of data capacity for data sets including, but not limited to, summary data, structured/unstructured, raw data feeds, call logs, web logs, etc.; and (iii) transformations needed to assess data quality and derive statistically useful measures. Regarding transformations, it is preferred that data is transformed after it is obtained, i.e., ELT (Extract, Load, Transform), as opposed to ETL (Extract, Transform, Load). However, the transformation paradigm can be ETLT (Extract, Transform, Load, Transform again), in order to attempt to encapsulate both approaches of ELT and ETL. In either the ELT or ETLT case, this allows analysts to choose to transform the data (to obtain conditioned data) or use the data in its raw form (the original data). Examples of transformation tools that can be available as part of the data analytic sandbox 124 include, but are not limited to, Hadoop™ (Apache Software Foundation) for analysis, Alpine Miner™ (Alpine Data Labs) for creating analytic workflows, and R transformations for many general purpose data transformations. Of course, a variety of other tools may be part of the data analytic sandbox 124.

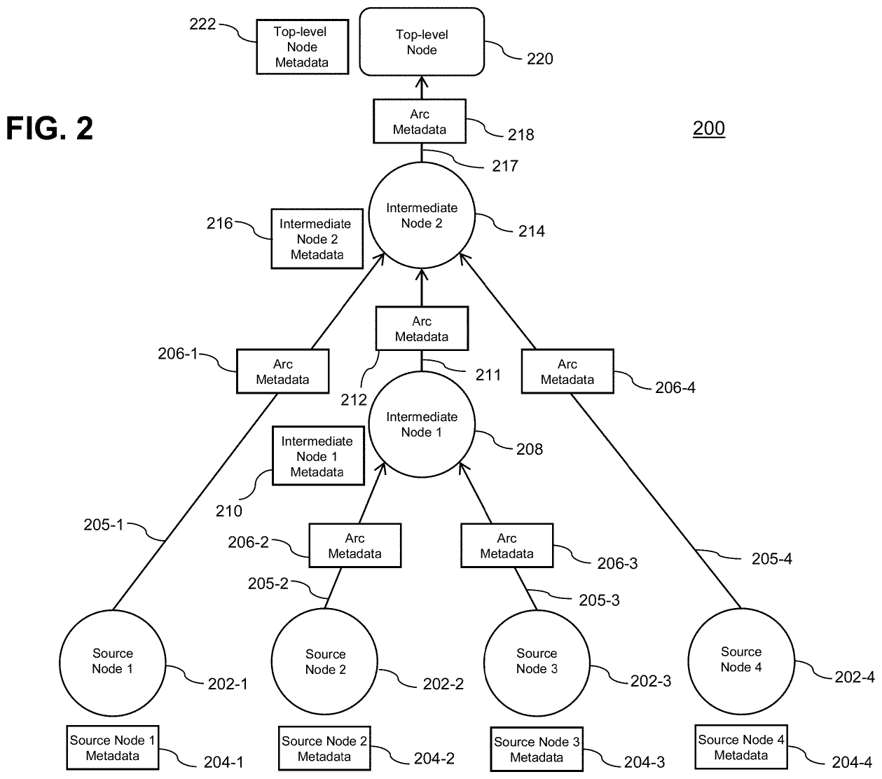

The value tree generation engine 122 is configured to generate, during the course of execution of the analytic process in the analytic sandbox 124, a value tree (i.e., data structure) comprising value tree elements, wherein the value tree elements represent attributes associated with execution of the analytic process. In the examples to follow, the value tree elements comprise nodes and arcs connecting the nodes. An example of a value tree will be described below in the context of FIG. 2. The engine 122 also assigns value to at least a portion of the value tree elements (e.g., the nodes and/or arcs). Assignment of value can occur in conjunction with data lake valuation framework 112. That is, previously calculated values associated with the data sets 114 can be used by the engine 122 to assign value to the elements of the value tree. However, values may be independently calculated by the engine 122.

It is to be appreciated that the creation of a value tree can also occur in the analytic sandbox 124, as well as other places, e.g., within the data lake, in the location where it is ultimately archived, or any other suitable place.

FIG. 2 illustrates an example of a value tree, according to an embodiment of the invention. It is to be understood that the value tree shown in FIG. 2 is just one example of a data structure used to provide valuation information for purposes of illustrative embodiments. As shown, value tree 200 comprises multiple nodes connected by multiple arcs, with metadata associated with each node and each arc. Note that the number of nodes and arcs shown in FIG. 2 are intended to be examples, and a value tree can therefore have more or less elements. Nodes, in this example, comprise source nodes 202-1 through 202-4 (the source nodes respectively having metadata 204-1 through 204-4 associated therewith), intermediate nodes 208 and 214 (the intermediate nodes respectively having metadata 210 and 216 associated therewith), and a top-level (or end-level) node 220 (the top-level node having metadata 222 associated therewith).

As further shown in FIG. 2, the various nodes are connected via arcs (i.e., connectors). Arcs 205-1 and 205-4 connect source nodes 202-1 and 202-4 to intermediate node 214 (the arcs respectively having metadata 206-1 and 206-4 associated therewith). Arcs 205-2 and 205-3 connect source nodes 202-2 and 202-3 to intermediate node 208 (the arcs respectively having metadata 206-2 and 206-3 associated therewith). Arc 211 connects intermediate node 208 with intermediate node 214 (the arc having metadata 212 associated therewith). Arc 217 connects intermediate node 214 with top-level node 220 (the arc having metadata 218 associated therewith).

It is to be appreciated that the phrase “associated with” in this context means that data and/or metadata (e.g., descriptive metadata, values, or other types of metadata) is stored within the data structure of the data value tree in such a manner that when a node or arc is queried or otherwise accessed, the data and/or metadata for the node or arc is read or written to. A database structure, a graphical structure, or another functionally similar structure can be employed to realize the data structure. It is also to be appreciated that data and/or metadata mentioned herein as being associated with a given node can alternatively be associated with a corresponding, connecting arc, and vice versa.

In one use case example, assume the value tree is being generated for some business purpose. Assume further that the bottom level nodes (source nodes 202-1 through 202-4) in the value tree 200 contain descriptive metadata (204-1 through 204-4) about four original data sources, and the arcs (205-1 through 205-4) connected to the nodes represent transforms conducted on the data sources by data scientists. Metadata (206-1 through 206-4) about the data scientist, the transform tools used, and/or the nature of the work is associated with the arcs in the data value tree. These arcs lead to intermediate results (208 and 214) that likewise contain descriptive metadata (210 and 216) about the intermediate results. Further transforms are applied to the intermediate results and represented by arcs (211 and 217) and respectively described by metadata (212 and 218). The value tree eventually is topped by a report (node 220 and metadata 222) that contains a recommendation to help the business. In one example, a recommendation is generated at this top-level node that results in a potentially significant monetary savings to the business. The projected savings are potentially achievable by operationally implementing the recommendation described in the top-level node. The recommendation may likely involve incorporating certain process changes and/or new processes within the business. As described herein, after the recommendation is implemented by the business, actual cost savings will then be known, and the value tree can then be updated with the actual values. The actual values of each contributing data set (node) that yielded the recommendation can then be determined from the updated tree. This information can then be used by the business in many ways.

Further illustrative details of value tree generation will now be described.

The building of a value tree 200 in analytic sandbox 124 involves a variety of activities including, for example as mentioned above, ELT activity into the analytic sandbox. As each data set flows into the analytic sandbox, any valuation metadata currently being tracked by the larger data lake 110 can flow into the value tree (and be stored as metadata). Similarly, as the value tree is being built and modified in the analytic sandbox, the value tree can communicate metadata and results back into a larger valuation framework such as framework 112. If there is no larger valuation framework available, the value tree can be built in isolation.

Once all data sources have been obtained by the analytic sandbox 124, the data scientist begins generating intermediate data sets using one or more source inputs and one or more toolsets. Once these intermediate data sets have been generated completely, for example, the stage is marked via the addition of an intermediate node in the value tree, and an arc is created attaching this new node to any of the data sources involved in its creation. The intermediate node stores metadata related to its contents (e.g., the tables or keywords common in the intermediate data set). Timestamps and other system metadata can also be stored. The storage of nodes (and arcs) can be accomplished using any number of repositories, including structured databases and/or graph packages.

Furthermore, as a value tree is being built, the cardinality (i.e., number of arcs emanating from a node) can be calculated and used in subsequent valuation algorithms. A data scoring methodology can be employed to store the score at each of the corresponding nodes based on the number of arcs that are connected.

Still further, when a value is assigned to a node in the value tree, it can be added to the tree along with a valuation algorithm that will run down from the top node and assign value to each piece of data visited on the way. This approach allows for immediate in-line valuation to occur during the building of a value tree. Examples of algorithms that can be executed include, but are not limited to: round robin distribution of value; neural net techniques (e.g., backpropagation); call-outs to a data lake valuation framework; value based on tool(s) used; value based on scientist(s) involved; or any combination of the above.

As mentioned above, in the context of a data marketplace environment, illustrative embodiments contemplate the generation and use of data structures for data valuation purposes other than value tree 200.

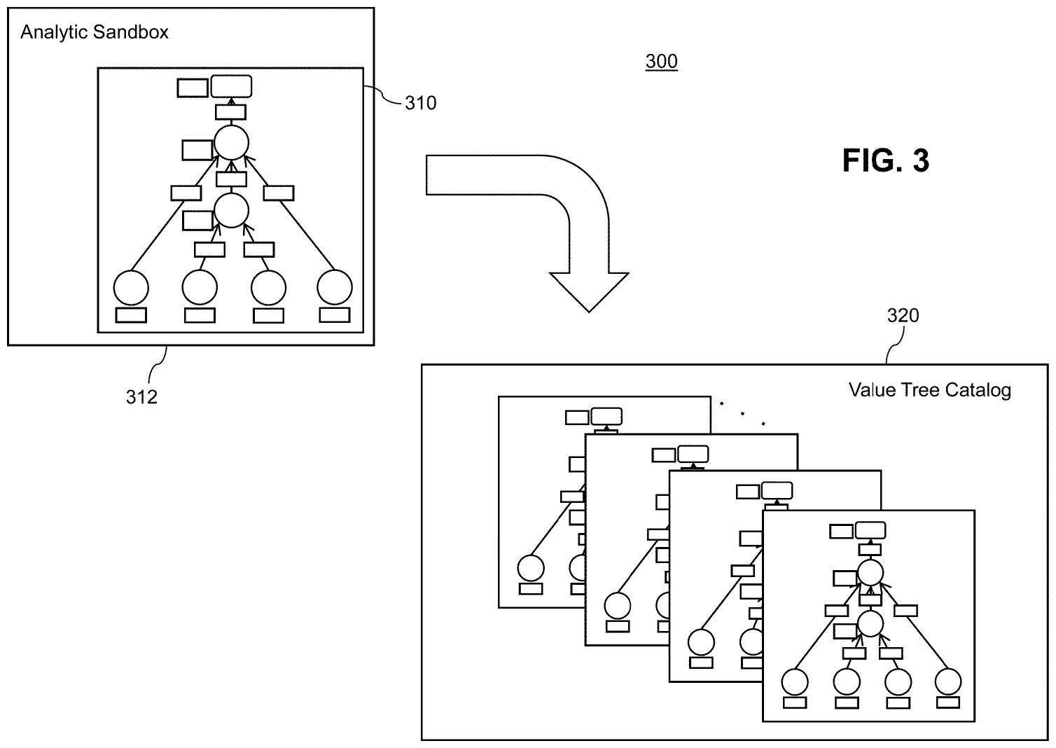

FIG. 3 illustrates a methodology for storing value trees, according to an embodiment of the invention. As shown in methodology 300, a data value tree 310 is generated in analytic sandbox 312, e.g., as described above. The value tree 310 is stored in a value tree catalog 320 with one or more other data value trees generated in accordance with the execution of one or more other data analytic processes (other data science experiments) or in accordance with some non-transformational process (i.e., processes that involve the data set but do not necessarily transform it). Each value tree stored in catalog 320 can be queried. A query may include a read instruction (e.g., obtain data from a value tree), a write instruction (e.g., update a value tree), and/or some other instruction. The query can also be part of an audit process. It is to be understood that value trees can also be queried on their own, whether or not they exist in a catalog.

Value trees can be stored in any number of ways including, but not limited to, immutable content stores (e.g., Centera storage system). A value tree can also be stored with a final report or recommendation generated by the data analytic process for which the tree was built, as mentioned above. A value tree can also be stored on an object-based system, return an object identifier (ID), and that object could be permanently bound to the analytic recommendation as part of its permanent metadata. The value tree catalog 320 can track, for example, every data science project being conducted in a data lake (110 in FIG. 1). Furthermore, the catalog 320 can be stored in data lake 110, analytic computing environment 120, a separate computing system, or some combination thereof.

In some embodiments, the value tree stores data per analytic project and persists even when the data and/or the analytic sandbox is destroyed. In addition, the value tree catalog contains a history of the scientists and the tools involved and closely associates them with the data. Further, in some embodiments, the value tree serves as a snapshot image of the high-level business value of the overall experiment, the data sources involved, and the perceived value of all of those contributing data sources at the time that the prediction was made.

Still further, the value tree catalog (or archive) allows a lookup function for any given value tree. If a particular data science project resulted in an operationalized recommendation, the tree associated with that recommendation can be fetched from the catalog and loaded into memory. The actual value can then be attached to the top-level node (the original predicted value can still be saved). When the actual value is loaded, the value tree can likewise provide valuation algorithms that can propagate actual value to contributing nodes. This new value tree can be contributed back into the catalog, either as a replacement value tree or a versioned value tree. Furthermore, value trees can be modified directly in the catalog if necessary. A report can be associated with the value tree (e.g., plan post-mortem analysis on how the recommendations were executed).

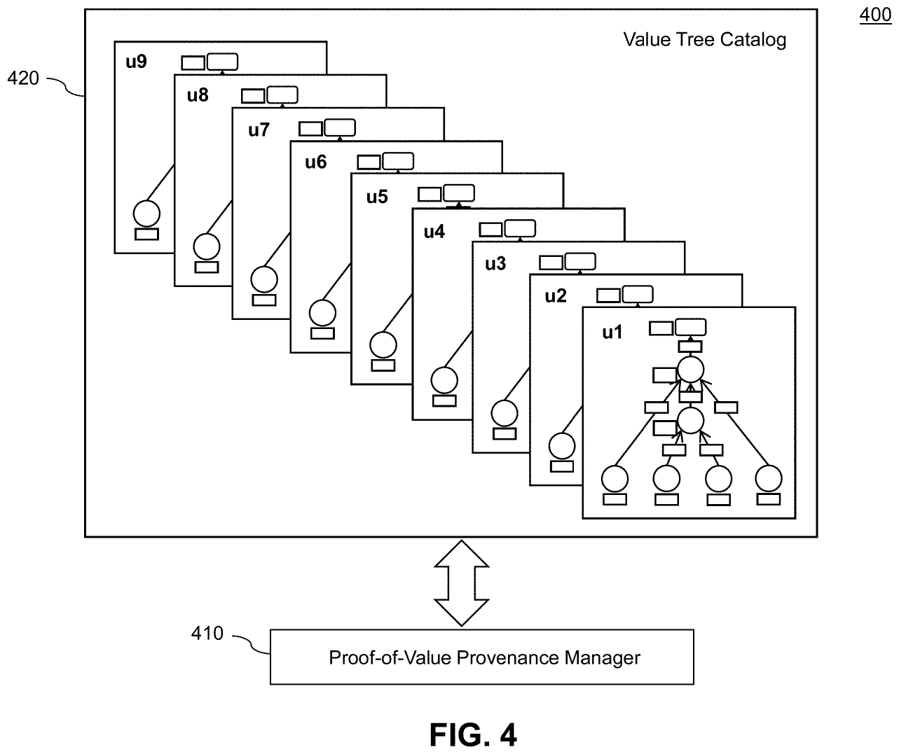

While a value tree catalog, such as value tree catalog 320, can help a corporation track the value of their data assets, they can also be used to assist in the leveraging (e.g., monetization) of data assets in external data marketplaces, as will be further explained below in the context of FIGS. 4-8.

FIG. 4 illustrates a proof-of-value provenance manager and corresponding environment according to an illustrative embodiment. More particularly, as shown in environment 400 in FIG. 4, a proof-of-value provenance manager 410 accesses the plurality of value trees in a value tree catalog 420 to generate further data valuation information that is subsequently presented to potential data consumers in a data marketplace environment. In one or more illustrative embodiments, one or more value trees in catalog 420 are generated as explained above (e.g., in FIGS. 1-3). Additionally or alternatively, one or more value trees in catalog 420 can be generated in other ways.

In one or more illustrative embodiments, as each value tree is stored in data value catalog 420, it is assigned a unique value that is calculated based on a cryptographic hash of the content. The cryptographic hash calculation can be done in a variety of ways including, in one embodiment, storing the value trees in an object-addressable storage system. As illustrated in value tree catalog 420, unique hash values u1-u9 are calculated for the different value trees stored for a given piece of content. In some embodiments, the hash value calculations are performed by a value tree generation engine (122 in FIG. 1), while in other embodiments, proof-of-value provenance manager 410 performs the hash value calculations. The hash value calculation can be performed in any suitable conventional manner so long as a unique reference is generated for each value tree.

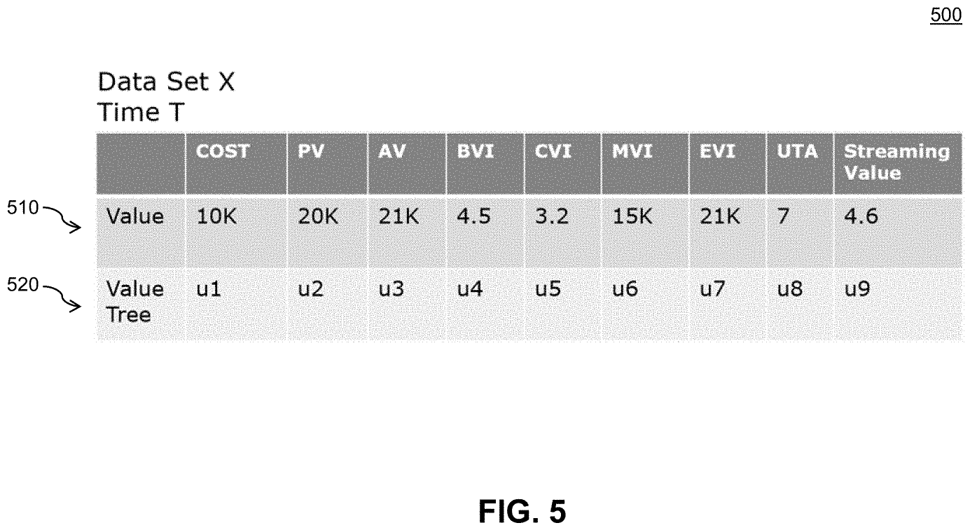

FIG. 5 illustrates a valuation table 500 with value tree references according to an illustrative embodiment. More particularly, in one or more illustrative embodiments, proof-of-value provenance manager 410 is configured to generate one or more valuation tables with value tree references. It is to be appreciated that a valuation table keeps track of content values at any given point in time.

As shown in FIG. 5, valuation table 500 is generated for a Data Set X at a Time T. Valuation table 500 contains multiple valuation scores (in row 510) and references (using hash values u1-u9 in row 520) value trees that contain the historical proof of how each valuation score was calculated. By way of example only, table 500 shows nine different valuation scores that have been calculated for Data Set X at time T. For example, the acquisition cost (COST) of Data Set X was 10,000 dollars. The proof of this value is referenced by unique address u1. The business value of the information (BVI) was measured to be 4.5 at time T, and the proof-of-value calculation was recorded in the value tree referenced by hash value u4.

Note that the example value tree 200 from FIG. 2 is a traditional analytic value flow in which source data sets are transformed into intermediate sets and ultimately into an end-user file. However, as mentioned above, there may be examples where data sets are not transformed but are exchanged and/or purchased. In such embodiments, valuation table 500 contains a reference to a tree that stores a receipt (e.g., points to a blockchain transaction in which one party exchanged cryptocurrency with another party for a COST of $10,000). This receipt serves as a proof-of-value that the cost was indeed paid to acquire the file.

Another type of value tree that is not strictly transformational (e.g., created as a result of an analytic algorithm) is a data object that undergoes a value change based on enrichment and/or editing operations, e.g., cleaning, upgrading, replacing, or adding to a data set in order to improve overall data quality (however, in some embodiments, enriching data can be part of an analytic process). In the data enrichment case, as mentioned above in the context of FIG. 2, the value tree contains nodes that represent the same data entity, with arcs that represent the type of enrichment that occurred (e.g., cleaning).

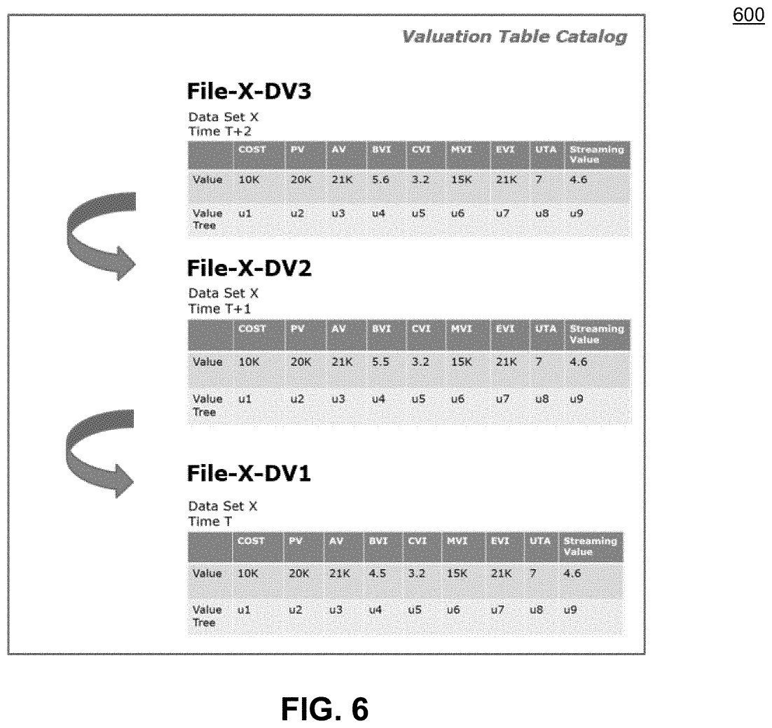

As data processing and improvement results in the ingest of new data sets (e.g., via purchase), modification and enrichment of data sets, and the creation of new data sets via analytics, periodic valuation continually occurs as well. As such, in illustrative embodiments, as valuation tables are generated by proof-of-value provenance manager 410, these valuation tables are also stored and assigned unique hash values (e.g., “File-X-DV1”, “File-X-DV2”, etc.) that reference each other with back pointers. FIG. 6 illustrates valuation table versioning and highlights how a valuation table catalog 600 can increase and grow over time. In the example shown in FIG. 6, the business value of the information (BVI) continually increases (4.5 at Time T, 5.5 at Time T+1, and 5.6 at Time T+2), and back pointers from the most-recent version to least-recent version are maintained. This provenance is extremely useful, as further described below.

Using techniques described above, data sets can now be advertised for sale with a rich set of provenance information that proves that the asking price for the data set is reasonable. For example, in some embodiments, techniques for advertising the data set involve providing the most-recent valuation table (e.g., the valuation table referenced as File-X-DV3 in FIG. 6) for the file.

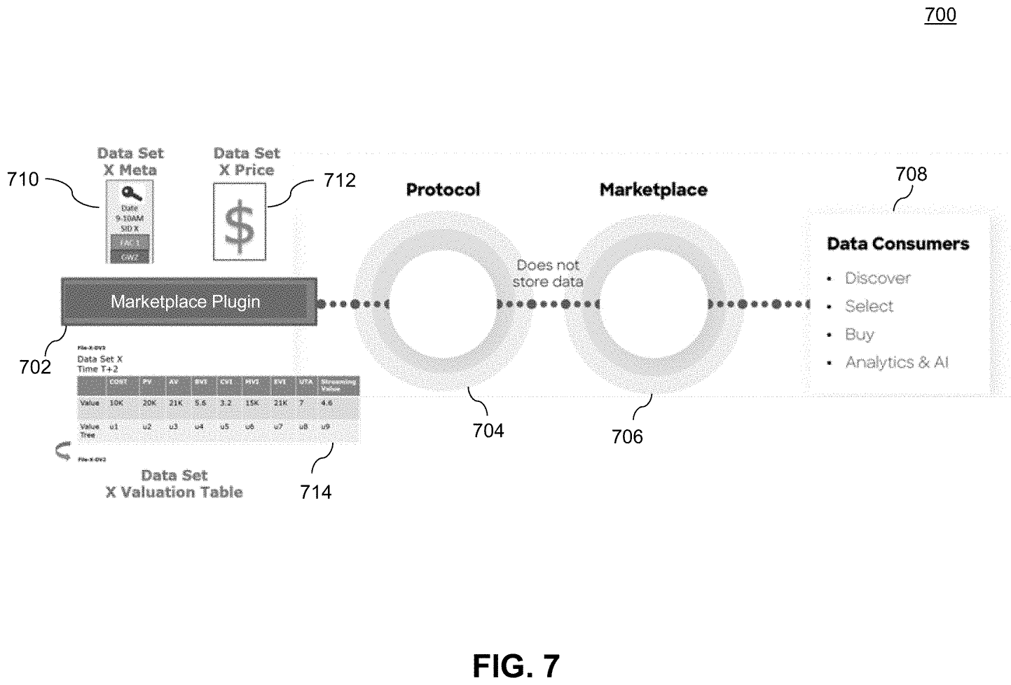

FIG. 7 illustrates a process 700 of advertising a valuation table in a data marketplace environment according to an illustrative embodiment. Assume that proof-of-value provenance manager 410 has access to a given marketplace plugin module 702, which is an interface that allows a data owner/producer to access a given data marketplace platform. In one example, assume that protocol 704 is the Ocean protocol and marketplace 706 is the DEX data marketplace. The Ocean Protocol (available from Ocean Protocol Foundation Ltd., Singapore) is a decentralized data exchange protocol that can match data producers to data consumers 708 (e.g., corporate artificial intelligence (AI) algorithms willing to pay for certain types of data). As shown, further assume that marketplace plugin 702 is used to advertise Data Set X. In addition to minimal information about the data set (as mentioned above) such as basic identifying metadata 710 (e.g., content, size, creation date) and a corporate price 712 of the data (e.g., how much the data owner is selling the data set for), the latest version of valuation table 714 (e.g., the valuation table referenced as File-X-DV3 in FIG. 6) is also shared.

In some alternative embodiments:

(i) Only the hash of the valuation table (“File-X-DV3”) is shared. In such a scenario, the data seller is stating that it has proof-of-value provenance information (e.g., value trees) for this data set.

(ii) Only the fields for which provenance information (e.g., value trees) is available (e.g., COST, BVI, EVI, etc.), without sharing values and/or references to those provenance data structures.

(iii) All provenance information is shared including the value trees, etc.

Each option described above (i through iii) involves revealing more information about how value was internally calculated by the data seller. Selectively revealing this information can result in many advantages.

For example, a data seller that withholds some level of information about proof-of-value may be doing so in order to be compensated for providing the actual values, and/or the value trees that prove how the values were calculated. Non-limiting examples of various possible data seller intentions include:

(i) I have proof-of-value fields. Pay me and I will tell you what those fields are.

(ii) For any given proof-of-value field, pay me and I will tell you the value of that field.

(iii) For any given value calculated for any given field, pay me and I will send you the proof-of-value information for that calculation.

(iv) For any given valuation table, pay me and I will provide you some level of history of valuation tables from previous points in time.

Such scenarios provide a data seller with some compensation for the expense of continually keeping track of the value of data. In some embodiments, this compensation is transferred as part of a smart contract operation, in which values and/or value trees are exchanged and cryptocurrency tokens flow to the seller per the contract.

As data buyers purchase data sets based on proof-of-value, in some embodiments, these purchases can also be provided as proof-of-value. As data buyers become aware that a certain data set is being repeatedly purchased, this may also influence their decision to purchase that data set or not purchase it.

Should a data buyer purchase and receive a data set, in certain embodiments, the data seller can provide some incentive for the buyer to eventually share the value that they received post-purchase. This feedback may result in a discounted rate for the buyer, or a promised return of part of the price when feedback is given. This feedback becomes another proof-of-value data point that the data seller can use to entice future buyers to purchase a data set. It can also be used as justification to charge a higher price.

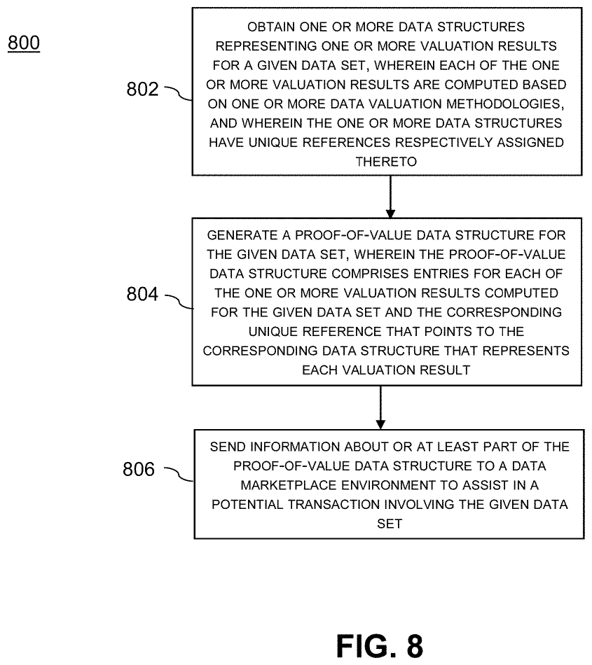

Given detailed descriptions herein, FIG. 8 generally illustrates a data valuation methodology 800 for a data marketplace environment according to an illustrative embodiment.

As shown, step 802 obtains one or more data structures representing one or more valuation results for a given data set, wherein each of the one or more valuation results are computed based on one or more data valuation methodologies, and wherein the one or more data structures have unique references respectively assigned thereto.

Step 804 generates a proof-of-value data structure for the given data set, wherein the proof-of-value data structure comprises entries for each of the one or more valuation results computed for the given data set and the corresponding unique reference that points to the corresponding data structure that represents each valuation result.

Step 806 sends information about or at least part of the proof-of-value data structure to a data marketplace environment to assist in a potential transaction involving the given data set.

In one or more embodiments, the methodology updates the proof-of-value data structure following a transaction involving the given data set.

In one or more embodiments, the one or more data structures representing the one or more valuation results comprise one or more value trees, which are stored in a value tree catalog, and wherein each value tree is accessible by its unique reference. Each of the unique references are computed as a unique hash value based on the corresponding data structure.

In one or more embodiments, the proof-of-value data structure comprises a data table. Multiple versions of the proof-of-value data structure are maintained for the given data set, wherein each version represents a given time instance. Each of the multiple versions have a unique reference assigned thereto.

In one or more embodiments, data valuation methodologies used to compute a valuation result comprise one or more transformational processes involving the given data set, one or more non-transformational processes involving the given data set, or some combination of both.

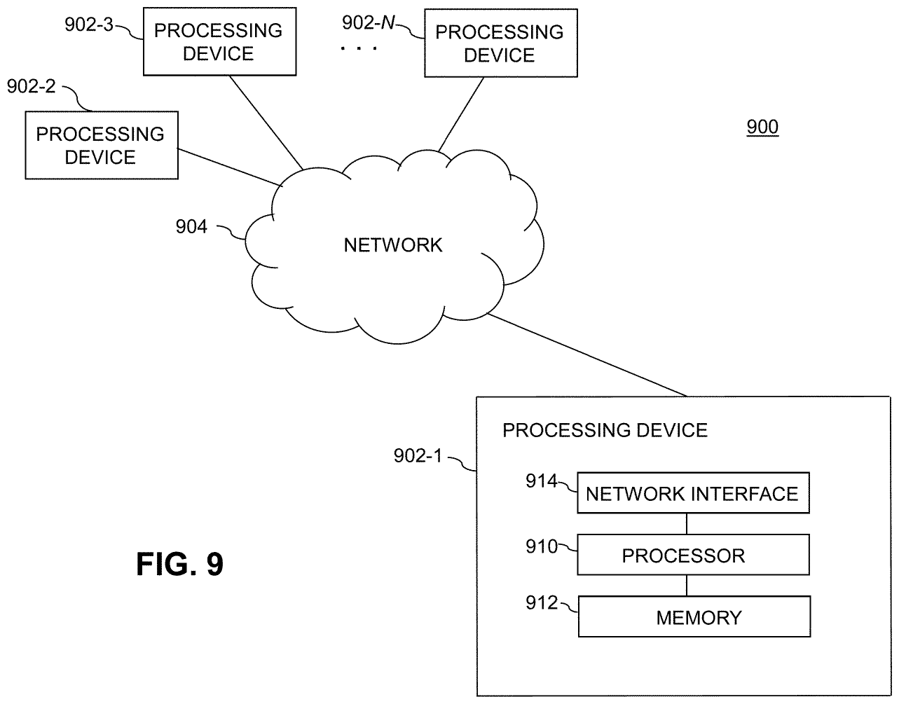

As an example of a processing platform on which a data valuation methodology for a data marketplace environment (as shown in FIGS. 1-8) according to illustrative embodiments can be implemented is processing platform 900 shown in FIG. 9. The processing platform 900 in this embodiment comprises a plurality of processing devices, denoted 902-1, 902-2, 902-3, . . . 902-N, which communicate with one another over a network 904. It is to be appreciated that methodologies described herein may be executed in one such processing device 902, or executed in a distributed manner across two or more such processing devices 902. Thus, the framework environment may be executed in a distributed manner across two or more such processing devices 902. The various functionalities described herein may be executed on the same processing devices, separate processing devices, or some combination of separate and the same (overlapping) processing devices. It is to be further appreciated that a server, a client device, a computing device or any other processing platform element may be viewed as an example of what is more generally referred to herein as a “processing device.” As illustrated in FIG. 9, such a device comprises at least one processor and an associated memory, and implements one or more functional modules for instantiating and/or controlling features of systems and methodologies described herein. Multiple elements or modules may be implemented by a single processing device in a given embodiment.

The processing device 902-1 in the processing platform 900 comprises a processor 910 coupled to a memory 912. The processor 910 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 910. Memory 912 (or other storage device) having such program code embodied therein is an example of what is more generally referred to herein as a processor-readable storage medium. Articles of manufacture comprising such processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 912 may comprise electronic memory such as random access memory (RAM), read-only memory (ROM) or other types of memory, in any combination. The one or more software programs when executed by a processing device, such as the processing device 902-1, causes the device to perform functions associated with one or more of the components/steps of system/methodologies in FIGS. 1-8. One skilled in the art would be readily able to implement such software given the teachings provided herein. Other examples of processor-readable storage media embodying embodiments of the invention may include, for example, optical or magnetic disks.

Processing device 902-1 also includes network interface circuitry 914, which is used to interface the device with the network 904 and other system components. Such circuitry may comprise conventional transceivers of a type well known in the art.

The other processing devices 902 (902-2, 902-3, . . . 902-N) of the processing platform 900 are assumed to be configured in a manner similar to that shown for processing device 902-1 in the figure.

The processing platform 900 shown in FIG. 9 may comprise additional known components such as batch processing systems, parallel processing systems, physical machines, virtual machines, virtual switches, storage volumes, etc. Again, the particular processing platform shown in this figure is presented by way of example only, and systems described herein may include additional or alternative processing platforms, as well as numerous distinct processing platforms in any combination.

Also, numerous other arrangements of servers, clients, computers, storage devices or other components are possible in processing platform 900. Such components can communicate with other elements of the processing platform 900 over any type of network, such as a wide area network (WAN), a local area network (LAN), a satellite network, a telephone or cable network, or various portions or combinations of these and other types of networks.

Furthermore, it is to be appreciated that the processing platform 900 of FIG. 9 can comprise virtual machines (VMs) implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 900 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It is to be noted that portions of the data valuation methodology for a data marketplace environment described herein may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention. Numerous other alternative embodiments within the scope of the appended claims will be readily apparent to those skilled in the art.

What is claimed is:

1. A method comprising:
obtaining one or more data structures representing one or more valuation results for a given data set, wherein each of the one or more valuation results are computed based on one or more data valuation methodologies, and wherein the one or more data structures have unique references respectively assigned thereto; and
generating a proof-of-value data structure for the given data set, wherein the proof-of-value data structure comprises entries for each of the one or more valuation results computed for the given data set and the corresponding unique reference that points to the corresponding data structure that represents each valuation result;
wherein the steps are performed by at least one processing device comprising a processor and a memory.

2. The method of claim 1, further comprising sending at least part of the proof-of-value data structure to a data marketplace environment to assist in a potential transaction involving the given data set.

3. The method of claim 1, further comprising sending information about the proof-of-value data structure to a data marketplace environment to assist in a potential transaction involving the given data set.

4. The method of claim 1, further comprising updating the proof-of-value data structure following a transaction involving the given data set.

5. The method of claim 1, wherein the one or more data structures representing the one or more valuation results comprise one or more value trees.

6. The method of claim 5, storing the one or more value trees in a value tree catalog, wherein each value tree is accessible by its unique reference.

7. The method of claim 1, wherein each of the unique references are computed as a unique hash value based on the corresponding data structure.

8. The method of claim 1, wherein the proof-of-value data structure comprises a data table.

9. The method of claim 1, further comprising maintaining multiple versions of the proof-of-value data structure for the given data set, wherein each version represents a given time instance.

10. The method of claim 9, wherein each of the multiple versions have a unique reference assigned thereto.

11. The method of claim 1, wherein at least one of the data valuation methodologies used to compute a valuation result comprises a transformational process involving the given data set.

12. The method of claim 1, wherein at least one of the data valuation methodologies used to compute a valuation result comprises a non-transformational process involving the given data set.

13. An article of manufacture comprising a processor-readable storage medium having encoded therein executable code of one or more software programs, wherein the one or more software programs when executed by at least one processing device implement steps of:
obtaining one or more data structures representing one or more valuation results for a given data set, wherein each of the one or more valuation results are computed based on one or more data valuation methodologies, and wherein the one or more data structures have unique references respectively assigned thereto; and
generating a proof-of-value data structure for the given data set, wherein the proof-of-value data structure comprises entries for each of the one or more valuation results computed for the given data set and the corresponding unique reference that points to the corresponding data structure that represents each valuation result.

14. The article of claim 13, further comprising sending at least part of the proof-of-value data structure to a data marketplace environment to assist in a potential transaction involving the given data set.

15. The article of claim 13, further comprising sending information about the proof-of-value data structure to a data marketplace environment to assist in a potential transaction involving the given data set.

16. The article of claim 13, further comprising updating the proof-of-value data structure following a transaction involving the given data set.

17. An apparatus comprising:
at least one processor operatively coupled to at least one memory configured to:
obtain one or more data structures representing one or more valuation results for a given data set, wherein each of the one or more valuation results are computed based on one or more data valuation methodologies, and wherein the one or more data structures have unique references respectively assigned thereto; and
generate a proof-of-value data structure for the given data set, wherein the proof-of-value data structure comprises entries for each of the one or more valuation results computed for the given data set and the corresponding unique reference that points to the corresponding data structure that represents each valuation result.

18. The apparatus of claim 17, wherein the processor is further configured to send at least part of the proof-of-value data structure to a data marketplace environment to assist in a potential transaction involving the given data set.

19. The apparatus of claim 17, wherein the processor is further configured to send information about the proof-of-value data structure to a data marketplace environment to assist in a potential transaction involving the given data set.

20. The apparatus of claim 17, wherein the processor is further configured to update the proof-of-value data structure following a transaction involving the given data set.
